(19) United States
(12) Patent Application Publication
(10) Pub. No.: US 2012/0105660 A1
(43) Pub. Date: May 3, 2012

(54) IMAGE PRODUCING APPARATUS

(75) Inventors: Naoki Ogasawara, Daito-shi (JP); Ryo Sakaji, Kyotanabe-shi (JP); Nobuhiko Ichii, Hirakata-shi (JP)

(73) Assignee: SANYO ELECTRIC CO., LTD., Osaka (JP)

(21) Appl. No.: 13/284,589

(22) Filed: Oct. 28, 2011

(30) Foreign Application Priority Data
Oct. 29, 2010 (JP) 2010-243141

(51) Int. Cl. H04N 9/04; H04N 5/262; G06F 3/041; H04N 5/225; H04N 9/73; G06K 9/62

(52) U.S. Cl. 348/220.1; 348/223.1; 348/E09.051; 348/E05.024; 348/E05.051; 348/E09.002

(57) ABSTRACT

An image producing apparatus according to the present invention includes a control unit configured to switch from an operation mode of a face detection automatic exposing/focusing unit to an operation mode of a color detection automatic exposing/focusing unit when a single object region other than a face image is specified by a manipulation of a touch panel during an operation of the face detection automatic exposing/focusing unit, and to switch from the operation mode of the color detection automatic exposing/focusing unit to the operation mode of the face detection automatic exposing/focusing unit when a single face image is specified by a manipulation of the touch panel during an operation of the color detection automatic exposing/focusing unit.

The present application claims priority to Japanese Patent Application No. 2010-243141, which is incorporated herein by reference.

### BACKGROUND OF THE INVENTION

1. Field of the Invention

The present invention relates to an image producing apparatus such as a digital camera or a video camera.

2. Description of the Related Art

In conventional image producing apparatuses of this type, it is proposed to have a face detecting function for detecting at least one face image included in an image (a frame image) input by photographing, so as to track a person by the face detection of the person and automatically adjust an exposure condition or a focus to the person.

Alternatively, the apparatus may have a color detecting function for detecting a color of an area specified by a user, so as to track a person by the color detection of clothes of the person and automatically adjust an exposure condition or a focus to the person.

However, the automatic exposing function (AE function) and the automatic focusing function (AF function), which use a tracking function by the face detection according to the conventional art, have a problem that the performance of the tracking function by the face detection is rapidly deteriorated and an exposure condition or a focus cannot be accurately adjusted to a desired person once the face of the person as an object cannot be captured from the front with a change in the posture of the person.

### SUMMARY OF THE INVENTION

An image producing apparatus according to the present invention includes an display device for displaying a frame image generated sequentially by photographing, a touch panel provided to cover a screen of the image display device, a face detecting unit for detecting at least one face image contained in the frame image, a face detection automatic exposing/focusing unit for tracking a single face image specified by a manipulation of the touch panel to adjust an exposure and/or a focus, a color detecting unit for detecting a color of a single object region which is specified by a manipulation of the touch panel, and a color detection automatic exposing/focusing unit for tracking the single object region by the color detection adjust an exposure and/or a focus.

The image producing apparatus according to the present invention further includes a control unit configured to switch from an operation mode of the face detection automatic exposing/focusing unit to an operation mode of the color detection automatic exposing/focusing unit when a single object region other than a face image is specified by a manipulation of the touch panel during an operation of the face detection automatic exposing/focusing unit, and switching from the operation mode of the color detection automatic exposing/focusing unit to the operation mode of the face detection automatic exposing/focusing unit when a single face image is specified by a manipulation of the touch panel during an operation of the color detection automatic exposing/focusing unit.

### BRIEF DESCRIPTION OF THE DRAWINGS

FIG. 1 is a block diagram showing an electrical structure of a digital camera according to an embodiment of the present invention;

FIG. 2 is a flowchart representing a first part of a photographing mode switching control procedure;

FIG. 3 is a flowchart representing a second part of the photographing mode switching control procedure;

FIG. 4 is a view illustrating an example of an image display in a face detection photographing mode;

FIG. 5 is a view illustrating an example of an image display upon switching from the face detection photographing mode to a color detection photographing mode;

FIG. 6 is a view illustrating an example of an image display in the color detection photographing mode; and

FIG. 7 is a view illustrating an example of an image display upon switching from the color detection photographing mode to the face detection photographing mode.

### DETAILED DESCRIPTION OF THE PREFERRED EMBODIMENT

An embodiment of a digital camera according to the present invention will be specifically described below with reference to the drawings.

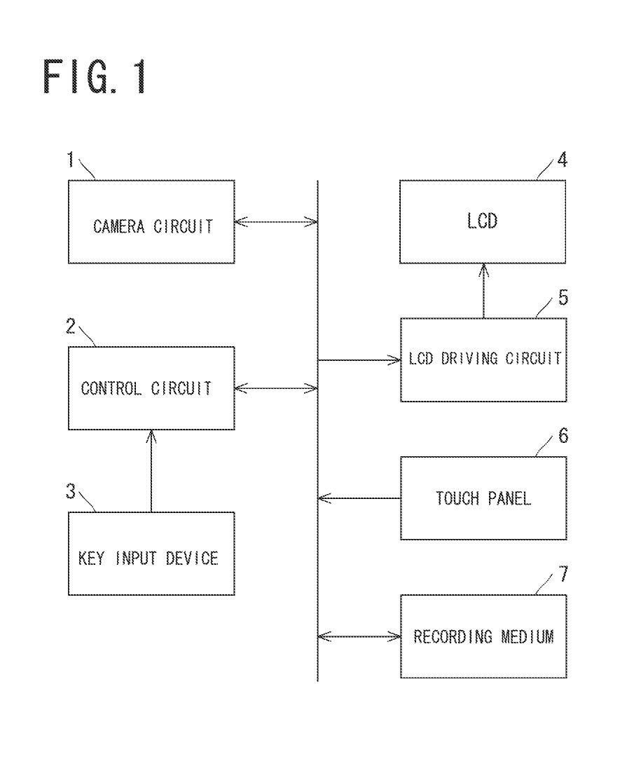

As shown in FIG. 1, the digital camera according to the embodiment of the present invention includes a camera circuit 1 having an image pickup device, a liquid crystal display device 4 for displaying a through-the-lens image obtained from the camera circuit 1 by photographing, an LCD driving circuit 5 for driving the liquid crystal display device 4, a touch panel 6 provided to cover a screen of the liquid crystal display device 4, a recording medium 7 for recording a still image or a moving image which is photographed, a key input device 3 such as a photographing button, and a control circuit 2 including a CPU for controlling operations of the camera circuit 1, the LCD driving circuit 5, and the recording medium 7 in response to a manipulation of the key input device 3 or the touch panel 6.

The control circuit 2 has a face detecting function for detecting at least one face image contained in a frame image, a face detecting AE/AF function for tracking a single face image specified by a manipulation of the touch panel 6 to adjust an exposure and a focus, a color detecting function for detecting a color of a single object region which is specified by a manipulation of the touch panel 6, and a color detecting AE/AF function for tracking the single object region adjust an exposure and a focus by the color detection.

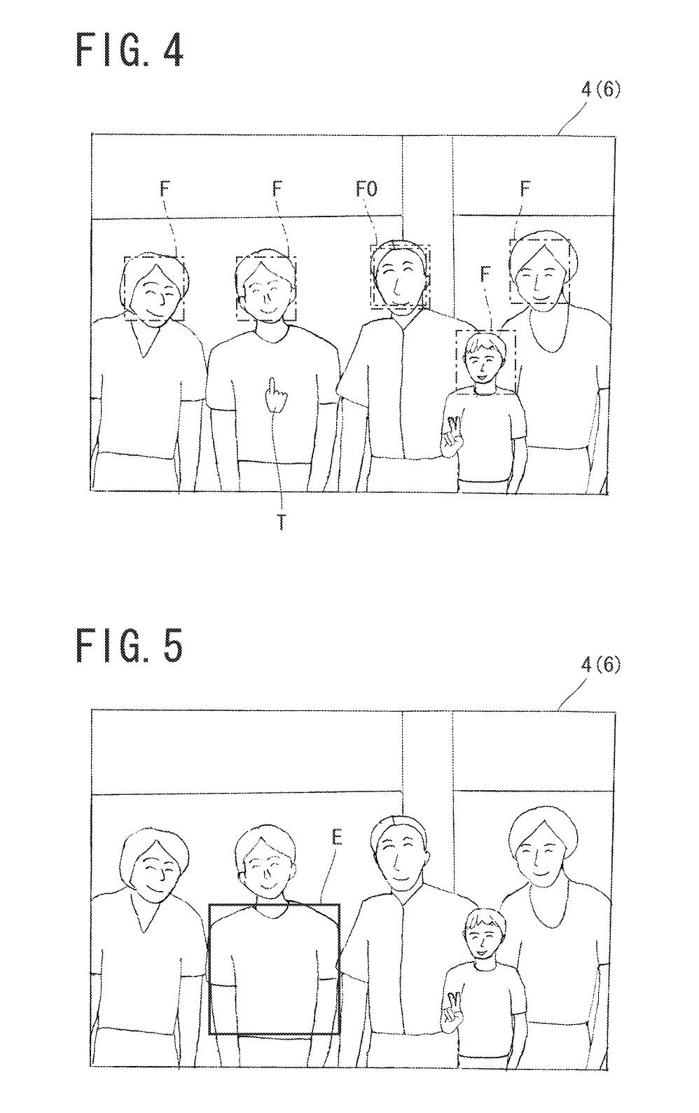

In the digital camera, as shown in FIG. 4, a plurality of face images contained in a through-the-lens image is detected in a state in which the through-the-lens image is displayed on a screen of the liquid crystal display device 4. In the example shown in the figure, each face image is surrounded by a frame F indicated by a dashed-dotted line, and a face image which is the closest to the central position of the screen is surrounded by a frame F0 indicated by a double dashed-dotted line in a default state, so that the AE/AF function is operated on the face image as a target.

In this state, when the touch panel 6 is touched at any position T in any object region other than a face image of a certain person (an image of clothes the person wears) as illustrated in FIG. 4, a color region having the same color as the touched object region is surrounded by a frame E indicated by a solid line as illustrated in FIG. 5, so that the AE/AF function is operated on an image in the color region as a target.

In this way, there is carried out switching from a face detection photographing mode for operating a face detecting AE/AF function a color detection photographing mode for operating a color detecting AE/AF function.

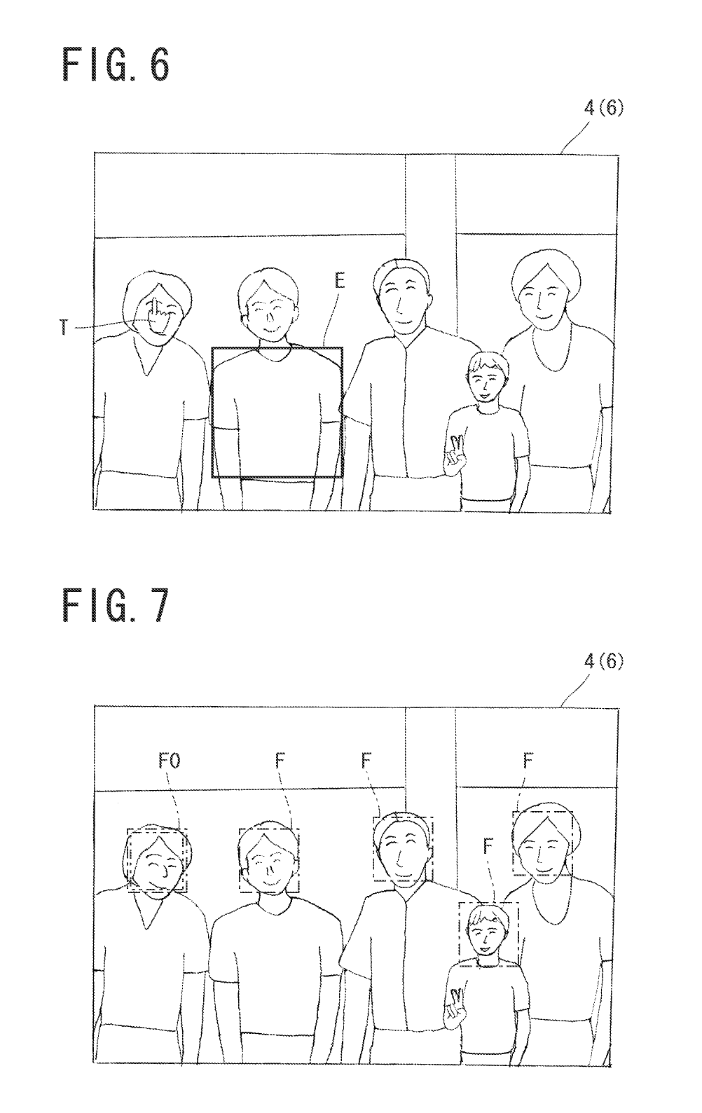

In the color detection photographing mode, when the touch panel 6 is touched at a position T a face image of a certain person as illustrated in FIG. 6, all of face images contained in a frame image are detected and each of the face images is surrounded by a frame F indicated by a dashed-dotted line, and furthermore, the touched face image is surrounded by a frame F0 indicated by a double dashed-dotted line as illustrated in FIG. 7, so that the AE/AF function is operated on the face image as a target.

In this way, switching from the color detection photographing mode to the face detection photographing mode is carried out.

In addition, when the touch panel 6 is touched at the position T in the color region other than a face image of a certain person (an image of clothes the person wears) as illustrated in FIG. 4, the touched color region is surrounded by a frame E indicated by a solid line as illustrated in FIG. 5, so that the AE/AF function is operated on the image of the color region as a target, and switching to the color detection photographing mode is carried out.

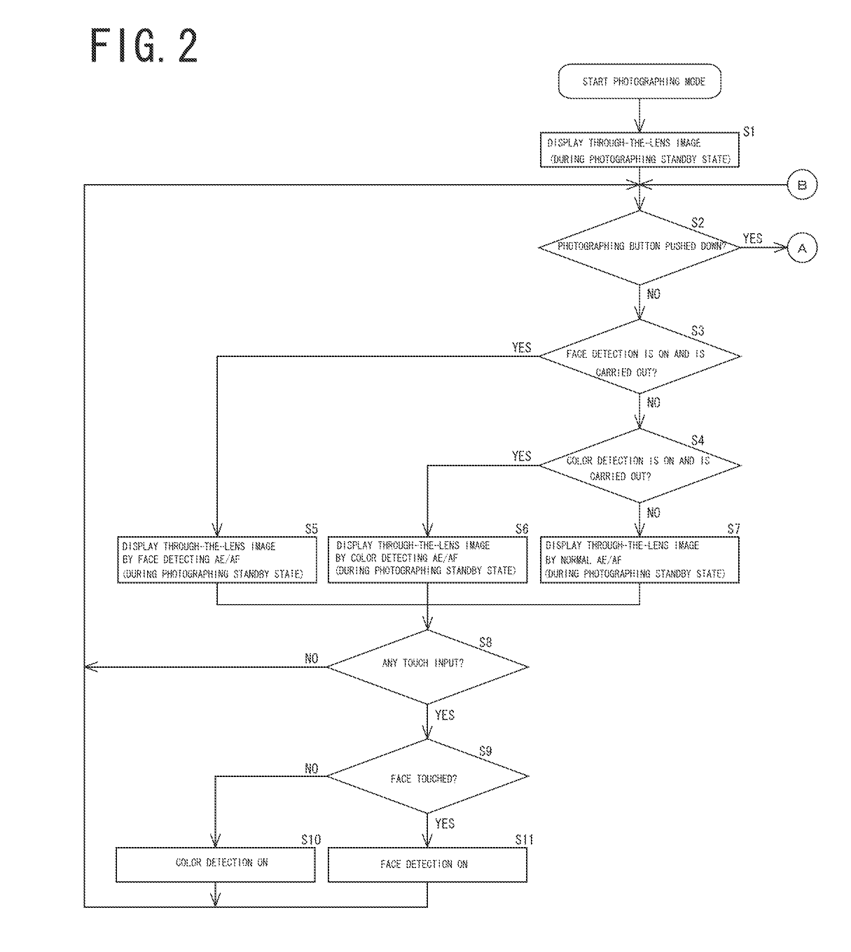

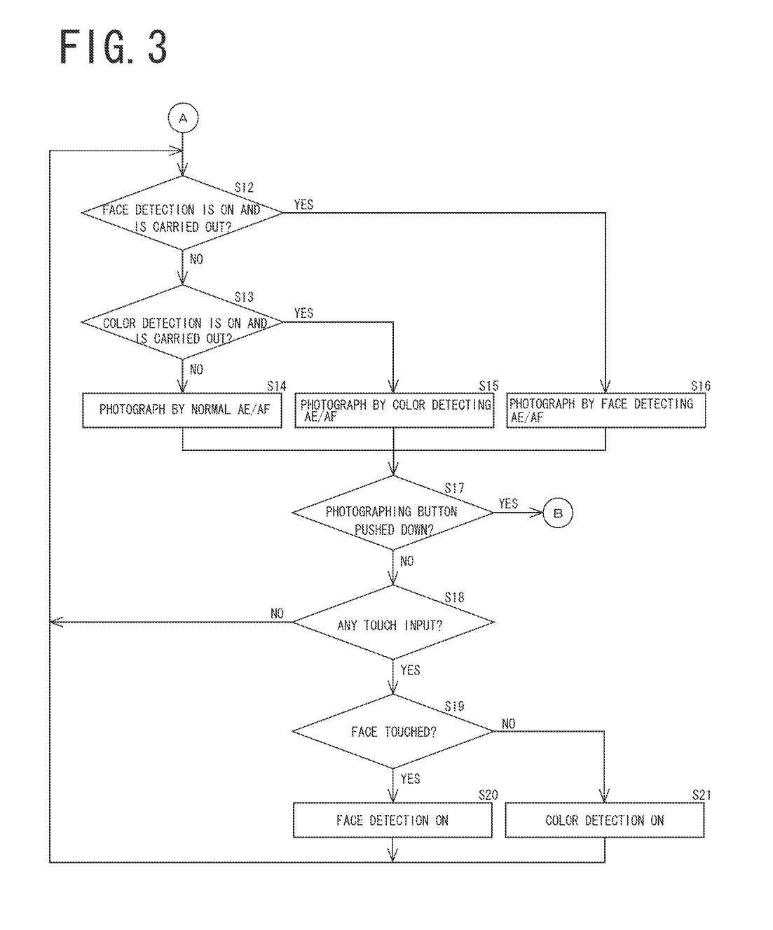

FIGS. 2 and 3 represent a control procedure of the control circuit 2 in a moving image photographing mode.

When the moving image photographing mode is set to start an operation as shown in FIG. 2, a through-the-lens image is first displayed on the screen and a photographing standby state is set in Step S1. In Step S2, it is then determined whether or not the photographing button is pushed down to start a moving image photographing operation. If the determination result is NO, the flow proceeds to Step S3 in which it is determined whether or not the face detecting function is ON and face detection is carried out.

If the determination result is YES in Step S3, the flow proceeds to Step S5 in which a through-the-lens image is displayed by the face detecting AE/AF function and the photographing standby state is set.

On the other hand, if the determination result is NO in Step S3, the flow proceeds to Step S4 in which it is determined whether or not the color detecting function is ON and color detection is carried out. If the determination result is YES, the flow proceeds to Step S6 in which a through-the-lens image is displayed by the color detecting AE/AF function and the photographing standby state is set.

If the determination result is NO in Step S4, the flow proceeds to Step S7 in which a through-the-lens image is displayed by the normal AE/AF function and the photographing standby state is set.

Thereafter in Step S8, it is determined whether or not a touch input is carried out. If the determination result is NO, the flow returns to and repeats Step S2 in which it is determined whether or not the photographing button is pushed down.

On the other hand, if the determination result is YES in Step S8, it is determined whether or not a face is touched in Step S9. If the determination result is NO, the flow proceeds to Step S10 in which the color detecting function is turned ON and the face detecting function is turned OFF.

If the determination result is YES in Step S9, the flow proceeds to Step S11 in which the face detecting function is turned ON and the color detecting function is turned OFF.

When the photographing button is pushed down to start a moving image photographing operation in a state in which the through-the-lens image is displayed, the determination result is YES in Step S2 so that the flow proceeds to Step S12 in FIG. 3. In Step S12, it is determined whether or not the face detecting function is ON and face detection is carried out.

If the determination result is YES in Step S12, the flow proceeds to Step S16 in which a moving image is photographed (recorded in the recording medium) by the face detecting AE/AF function.

On the other hand, if the determination result is NO in Step S12, the flow proceeds to Step S13 in which it is determined whether or not the color detecting function is ON and color detection is carried out. If the determination result is YES, the flow proceeds to Step S15 in which a moving image is photographed (recorded in the recording medium) by the color detecting AE/AF function.

If the determination result is NO in Step S13, the flow proceeds to Step S14 in which a moving image is photographed (recorded in the recording medium) by the normal AE/AF function.

Thereafter in Step S17, it is determined whether or not the photographing button is pushed down to end the moving image photographing operation. If the determination result is NO, the flow proceeds to Step S18 in which it is determined whether or not a touch input is carried out.

If the determination result is NO in Step S18, the flow returns to and repeats Step S12 in which it is determined whether the face detecting function is ON and face detection is carried out or not.

On the other hand, if the determination result is YES in Step S18, the flow proceeds to Step S19 in which it is determined whether or not a face is touched. If the determination result is YES in Step 19, the flow proceeds to Step S20 in which the face detecting function is turned ON and the color detecting function is turned OFF. If the determination result is NO in Step 19, the flow proceeds to Step S21 in which the color detecting function is turned ON and the face detecting function is turned OFF.

Then, the processing returns to and repeats Step S12 in which it is decided whether the face detecting function is ON and face detection is carried out or not.

If the determination result is YES in Step S17, the flow proceeds to and repeats Step S2 in FIG. 2 in which it is determined whether or not the photographing button is pushed down to start a moving image photographing operation.

According to the procedure described above, if a single object region other than a face image is specified by a manipulation of the touch panel during the operation of the face detecting AE/AF function, the color detecting function is turned ON and the face detecting function is turned OFF in Step S10 in FIG. 2. Thereafter, when the photographing button is pushed down to start a moving image photographing operation, a moving image is photographed (recorded in the recording medium) by the color detecting AE/AF function in Step S15 in FIG. 3.

When a single face image is specified by a manipulation of the touch panel during the operation of the color detecting AE/AF function, the face detecting function is turned ON and the color detecting function is turned OFF in Step S11 in FIG. 2. Thereafter, when the photographing button is pushed down to start a moving image photographing operation, a moving image is photographed (recorded in the recording medium) by the face detecting AE/AF function in Step S16 in FIG. 3.

Accordingly, a user can rapidly carry out the switching of the face detection photographing mode and the color detection photographing mode by a one-touch manipulation of the touch panel 6, and a manipulation of a menu screen is not required for the switching of the mode.

FIGS. 2 and 3 show the control procedure in the moving image photographing mode. It is noted that a control procedure during a photographing standby state in a still image photographing mode is carried out in almost the same manner.

As mentioned above, in the image producing apparatus according to the present invention, the face detecting unit and the color detecting unit are operated during a photographing standby state in which the frame image is displayed on the image display device to stand by for photographing a still image, or during a moving image photographing operation for recording the frame image in a recording medium while displaying the frame image on the image display device.

For example, when a single object region other than a face image is specified by a manipulation of the touch panel during the operation of the face detection automatic exposing/focusing unit, switching is carried out from an operation mode of the face detection automatic exposing/focusing unit (a face detection photographing mode) to an operation mode of the color detection automatic exposing/focusing unit (a color detection photographing mode) so that the specified single object region is tracked to execute a color detection automatic exposing/focusing operation for adjusting the exposure and/or the focus by the color detection of the object region.

Further, when a single face image is specified by the manipulation of the touch panel during the operation of the color detection automatic exposing/focusing unit, switching is carried out from an operation mode of the color detection automatic exposing/focusing unit (the color detection photographing mode) to an operation mode of the face detection automatic exposing/focusing unit (the face detection photographing mode) so that the specified single face image is tracked to execute the face detection automatic exposing/focusing operation for adjusting the exposure and/or the focus by the face detection of the face image.

It should be noted that the configuration of each portion according to the present invention is not restricted to the embodiment described above, and those skilled in the art could make various modifications without departing from the spirit of the present invention described in the claims. For example, the AE function in the color detection photographing mode or the face detection photographing mode can employ not only a configuration for targeting only one person as an object of the face detection or the color detection but also a configuration for targeting other people.

In order to display a frame indicative of a face detecting region and a frame indicative of a color detecting region, it is possible to employ various methods, such as a method of making a distinction by line types like a dashed-dotted line and a solid line, and a method of making a distinction by colors or blinking display.

What is claimed is:

1. An image producing apparatus' comprising:
A display device which displays a frame image generated sequentially by photographing;
a touch panel provided to cover a screen of the display device;
a face detecting unit which detects at least one face image contained in the frame image;
a face detection automatic exposing/focusing unit which adjusts an exposure and/or a focus to a single face image which is specified by a manipulation of the touch panel;
a color detecting unit which detects a color of a single object region which is specified by a manipulation of the touch panel;
a color detection automatic exposing/focusing unit which adjusts an exposure and/or a focus to the single object region by the color detection; and
a control unit configured to switch from an operation mode of the face detection automatic exposing/focusing unit to an operation mode of the color detection automatic exposing/focusing unit when a single object region other than a face image is specified by a manipulation of the touch panel during an operation of the face detection automatic exposing/focusing unit, and to switch from the operation mode of the color detection automatic exposing/focusing unit to the operation mode of the face detection automatic exposing/focusing unit when a single face image is specified by a manipulation of the touch panel during an operation of the color detection automatic exposing/focusing unit.

2. The image producing apparatus according to claim 1, wherein the face detecting unit and the color detecting unit are operated during a photographing standby state in which the frame image is displayed on the display device to stand by for photographing a still image, or during a moving image photographing operation for recording the frame image in a recording medium while displaying the frame image on the display device.

3. A method of producing an image using the image producing apparatus as defined in claim 1, the method comprising switching from an operation mode of the face detection automatic exposing/focusing unit to an operation mode of the color detection automatic exposing/focusing unit when a single object region other than a face image is specified by a manipulation of the touch panel during an operation of the face detection automatic exposing/focusing unit, and switching from the operation mode of the color detection automatic exposing/focusing unit to the operation mode of the face detection automatic exposing/focusing unit when a single face image is specified by a manipulation of the touch panel during an operation of the color detection automatic exposing/focusing unit.
